(19) United States
(12) Patent Application Publication
(10) Pub. No.: US 2026/0366336 A1
(43) Pub. Date: Nov. 19, 2026

(54) DOOR MECHANICAL SECURITY SYSTEM

(71) Applicant: Flip Lok LLC, Houston, TX (US)

(72) Inventor: John Reger, Houston, TX (US)

(21) Appl. No.: 19/212,187

(22) Filed: May 19, 2025

(51) Int. Cl. E05B 63/24; E05B 1/00; E05B 15/02

(52) U.S. Cl. CPC E05B 63/248; E05B 1/003; E05B 15/0205; E05B 2001/0076

(57) ABSTRACT

A door mechanical security system for use with an in-swing door having an interior lever handle assembly includes a major locking hinge assembly having a fixed mounting plate on the door frame, an elongated hinge pin assembly, and a swing plate supported for pivoting movement and translation movement between a locked lowermost position adjacent the door to obstruct the door from forced entry opening movement and an unlocked uppermost position adjacent the door frame and clear of the door travel path to enable opening movement of the door. An actuator assembly is adapted to lift a lifting cap affixed to the hinge pin assembly for lifting the swing plate.

### CROSS-REFERENCE TO RELATED APPLICATIONS

This application claims priority under 35 U.S.C. § 119 to U.S. Design patent application Ser. No. 29/856,566 filed Oct. 14, 2022 by applicant Flip Lok LLC, now U.S. Design Pat. No. D1,034,145 issued Jul. 9, 2024, for “PORTABLE DOOR LOCKING DEVICE” by inventor John Reger, which is hereby incorporated by reference in entirety. This application claims priority under 35 U.S.C. § 119 to U.S. Non-provisional patent application Ser. No. 18/508,138 filed Nov. 13, 2023 by applicant Flip Lok LLC for “DOOR SECURITY DEVICE” by inventor John Reger which is hereby incorporated by reference in entirety. This application claims priority under 35 U.S.C. § 119 to U.S. Provisional Patent Application 63/383,253 filed Nov. 10, 2022 by applicant Flip Lok LLC for “DOOR SECURITY DEVICE” by inventor John Reger, which is hereby incorporated by reference in entirety. This application claims priority under 35 U.S.C. § 119 to U.S. Non-provisional patent application Ser. No. 18/114,385 filed Feb. 27, 2023 by applicant Notrox LLC for “DOOR SECURITY DEVICE” by inventor John Reger, now U.S. Pat. No. 12,173,535 issued Dec. 24, 2024, which is hereby incorporated by reference in entirety. This application claims priority under 35 U.S.C. § 119 to U.S. Non-provisional patent application Ser. No. 17/881,025 filed Aug. 4, 2022 by applicant Notrox LLC for “DOOR SECURITY DEVICE” by inventor John Reger, now U.S. Pat. No. 11,619,083 issued Apr. 4, 2023, which is hereby incorporated by reference in entirety. This application claims priority under 35 U.S.C. § 119 to U.S. Non-Provisional application Ser. No. 17/532,418 filed Nov. 22, 2021 by applicant Notrox LLC for “DOOR SECURITY DEVICE” by inventor John Reger, now U.S. Pat. No. 11,447,993 issued Sept. 20, 2022, which is hereby incorporated by reference in entirety. This application claims priority under 35 U.S.C. § 119 to U.S. Non-provisional Application Ser. No. 17/520,309 filed Nov. 5, 2021 by applicant Notrox LLC for “Door Security Device” by inventor John Reger, now U.S. Pat. No. 11,859,421 issued Jan. 2, 2024, which is hereby incorporated by reference in entirety.

### FIELD OF THE INVENTION

The present disclosure relates to door mechanical security devices and systems.

### BACKGROUND OF THE INVENTION

Many governmental, commercial, and office buildings, such as schools, include substantial doors. Exterior doors typically are out-swing doors. Interior doors may be either in-swing or out-swing doors. Most are constructed of steel, although other materials may be used. The out-swing operation of doors often complies with building codes and best practices for fire safety. Doors may be locked to prevent entry. Doors are may be equipped with a panic bar to provide egress during a fire or other emergency, when people are in the building during regular business hours.

Schools have been the target of mass shootings. Doors located within the interior of large buildings, such as schools, may generally remain unlocked during school hours. If an active shooter attempts to open a classroom door, he/she may be met with an unlocked door or may confront and target staff immediately inside the classroom door, attempting manually to prevent the perpetrator from entering the classroom. This encounter can end in death or shooting injuries for the school staff and students targeted while attempting to prevent the perpetrator from entering the classroom through the door. The staff and students cannot readily see whether the classroom door is locked or unlocked, and may attract the attention of the armed perpetrator outside the door when the staff or student moves through the classroom to check whether the door is locked, lock the door if unlocked, or unlock the door to escape the classroom. In view of the preceding, need exists for improved door security devices.

### BRIEF SUMMARY OF THE INVENTION

The above-mentioned shortcomings, disadvantages and problems are addressed herein, as will be understood by those skilled in the art upon reading and studying the following specification. This summary is provided to introduce a selection of concepts in simplified form that are further described below in more detail in the Detailed Description. This summary is not intended to identify key or essential features of the claimed subject matter.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The present disclosure provides door mechanical security systems for securing a door against forced entry. The present disclosure provides door mechanical security apparatus for securing a door against forced entry. Apparatus, systems, and methods of varying scope are described herein. These aspects are indicative of various non-limiting ways in which the disclosed subject matter may be utilized, all of which are intended to be within the scope of the disclosed subject matter. In addition to the aspects and advantages described in this summary, further aspects, features, and advantages will become apparent by reference to the associated drawings, detailed description, and claims.

### BRIEF DESCRIPTION OF THE DRAWINGS

The novel features believed characteristic of the disclosed subject matter will be set forth in any claims that are filed later. The disclosed subject matter itself, however, as well as a preferred mode of use, further objectives, and advantages thereof, will best be understood by reference to the following detailed description of illustrative embodiments when read in conjunction with the accompanying drawings consisting of FIGS. 1-18.

FIG. 1 is an enlarged partial perspective view of a door mechanical security system in locked condition in use with an in-swing door having a lever-type pivoting door handle supported on a door body, the door mechanical security system including an articulating transmission in controlling relationship with a hinged locking device having a fixed plate mounted on the door frame and a gravity-biased swing plate supported on the fixed plate, wherein in the locked condition the swing plate occupies a locked lowermost position adjacent the major interior surface of the door body, wherein the lever-type pivoting door handle rests in a closed position with the articulating transmission in a corresponding disengaged resting position with a driving arm spaced apart from a lifting cap in locked position, the lifting cap affixed to a hinge pin to carry the gravity-biased swing plate from resting in the locked lowermost position for pivoting movement about the hinge pin vertical axis, in an exemplary embodiment.

FIG. 2 is an enlarged partial perspective view of the door mechanical security system shown generally in FIG. 1, in unlocked condition with the swing plate occupying the unlocked uppermost position adjacent the door frame and clear of the door body travel path, wherein the lever-type pivoting door handle rests in a closed position with the articulating transmission in a corresponding disengaged resting position with a driving arm spaced apart from the lifting cap in unlocked position, the lifting cap in the open position having pivoted away from the lifting cap locked position (shown in FIG. 1) about the hinge pin through a 180 degree range of travel to the lifting cap unlocked position, the lifting cap affixed to the hinge pin to carry the gravity-biased swing plate from resting in the locked lowermost position through the 180 degree range of travel for the swing plate to occupy an unlocked uppermost position adjacent the door frame and clear of the door body travel path, in an exemplary embodiment.

FIG. 3 is an enlarged partial front view of the door mechanical security system in the unlocked condition shown generally in FIG. 2 with the lifting cap in the unlocked position and swing plate occupying the unlocked uppermost position adjacent the door frame and clear of the door body travel path, in an exemplary embodiment.

FIG. 4 is an enlarged partial front view of the door mechanical security system in the locked condition shown generally in FIG. 1 with the lifting cap in the locked position and swing plate occupying the locked lowermost position adjacent the door body and obstructing the door body travel path, in an exemplary embodiment.

FIG. 5 is an enlarged partial first side view of the door mechanical security system in the locked condition shown generally in FIG. 1.

FIG. 6 is an enlarged partial second side view, opposite from the first side view seen in FIG. 5, of the door mechanical security system in the locked condition shown generally in FIG. 1.

FIG. 7 is an enlarged partial first side view of the door mechanical security system in the unlocked condition shown generally in FIG. 2.

FIG. 8 is an enlarged partial second side view, opposite from the first side view seen in FIG. 7, of the door mechanical security system in the unlocked condition shown generally in FIG. 2.

FIG. 9 is an enlarged partial top view of the door mechanical security system in the unlocked condition shown generally in FIG. 2.

FIG. 10 is an enlarged partial top view of the door mechanical security system in the locked condition shown generally in FIG. 1.

FIG. 11 is an enlarged partial bottom view of the door mechanical security system in the unlocked condition shown generally in FIG. 2.

FIG. 12 is an enlarged partial bottom view of the door mechanical security system in the locked condition shown generally in FIG. 1.

FIG. 13 is a partial front view of the door mechanical security system in the locked condition shown generally in FIG. 1 with the swing plate in the locked lowermost position.

FIG. 14 is a partial front view of the door mechanical security system in a first intermediate locked condition shown generally in FIG. 13 with the swing plate in the locked lowermost position and door handle depressed to move the driving arm upward to engage the lifting cap in the locked lowermost position to initiate lifting movement of the lifting cap from the locked lowermost position to a second intermediate unsecured uppermost position shown in FIG. 15.

FIG. 15 is a partial front view similar to FIG. 14, showing the door mechanical security system in a second intermediate unsecured condition shown with the lifting cap and swing plate raised to the unsecured uppermost position and the door handle depressed after moving the driving arm upward to lift the lifting cap and swing plate from the locked lowermost position (shown in FIG. 14) to the second intermediate unsecured uppermost position shown in FIG. 15, with the swing plate unsecured from the locked lowermost position.

FIG. 16 is a partial front view of the door mechanical security system in the unlocked condition shown generally in FIG. 2 with the swing plate in the uplocked uppermost position and pivoted 180 degrees in the final unlocked position adjacent the door frame and clear of the door body travel path.

FIG. 17 is a partial exploded view showing threaded fasteners for mounting the fixed plate to the door frame.

FIG. 18 is an enlarged partial perspective view similar to FIG. 1, with the lifting cap and swing plate shown in broken lines in an intermediate unsecured condition with the lifting cap and swing plate having been lifted from the locked lowermost position and having pivoted about 45 degrees along the 180 degrees range of travel towards the unlocked uppermost position, and thus partially clearing the door body travel path.

### DETAILED DESCRIPTION OF ILLUSTRATIVE EMBODIMENTS

In this detailed description, reference is made to the accompanying drawings which form a part hereof, and in which is shown by way of illustration specific embodiments which may be practiced. Reference now should be made to the drawings, in which the same reference numbers are used throughout the different figures to designate the same components. These embodiments are described in sufficient detail to enable those skilled in the art to practice the embodiments and disclosure. It is to be understood that other embodiments may be utilized, and that logical, mechanical, electrical, and other changes may be made without departing from the scope of the embodiments and disclosure. In view of the foregoing, the following detailed description is not to be taken as limiting the scope of the embodiments or disclosure.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be appreciated that for simplicity and clarity of illustration, where considered appropriate, reference numerals may be repeated among the figures to indicate corresponding or analogous elements. In addition, numerous specific details are set forth in order to provide a thorough understanding of the implementations described herein. However, it will be understood by those of ordinary skill in the art that the implementations described herein may be practiced without these specific details. In other instances, well-known methods, procedures and components have not been described in detail so as not to obscure the implementations described herein. Also, the description is not to be considered as limiting the scope of the implementations described herein.

The detailed description set forth herein in connection with the appended drawings is intended as a description of exemplary embodiments in which the presently disclosed apparatus and system can be practiced. The term “exemplary” used throughout this description means “serving as an example, instance, or illustration,” and should not necessarily be construed as preferred or advantageous over other embodiments.

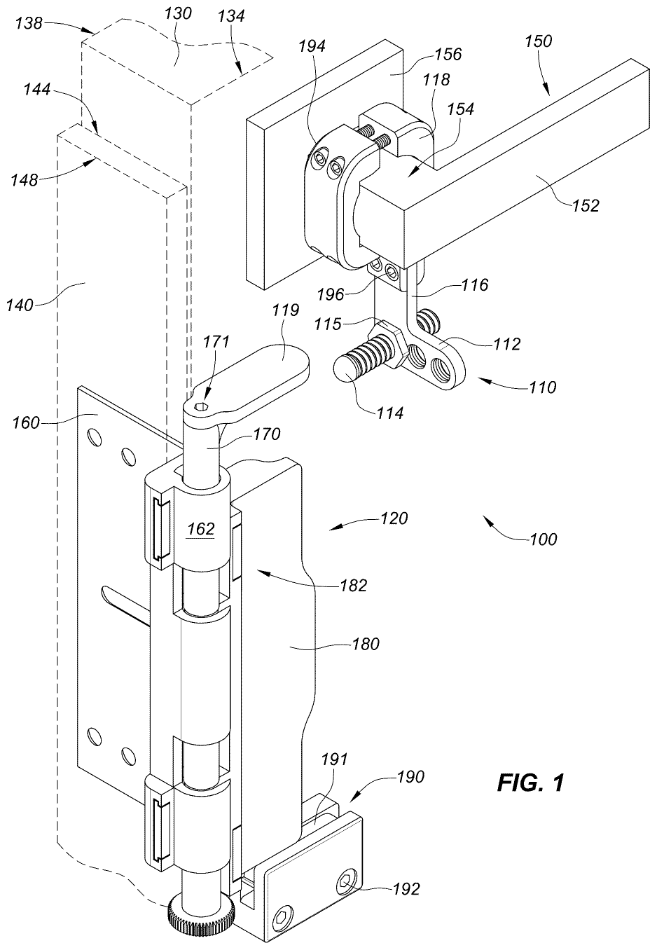

Illustrated in FIG. 1 is a partial perspective view showing a door mechanical security system 100 in use with an in-swing door 130 in an exemplary embodiment. Door mechanical security system 100 is adapted for securing the in-swing door 130 against forced entry movement away from the closed position of the door body (or “door”) relative to the door frame 140. To aid in understanding of the scope and utility of the disclosed subject matter, the reference “Parts of a Door Explained” by Diffey, N. (Salisbury Joinery blog dated Nov. 7, 2017) viewed Nov. 2, 2021 at the website salisburyjoinery. com/blog/parts-of-a-door-explained, published by Salisbury Joinery (Salisbury, UK), is incorporated by reference in entirety. The door frame 140 includes an elongated door jamb (not shown) that abuts the in-swing door 130 in closed position and prevents the door from moving beyond the closed position in relation to the door frame 140.

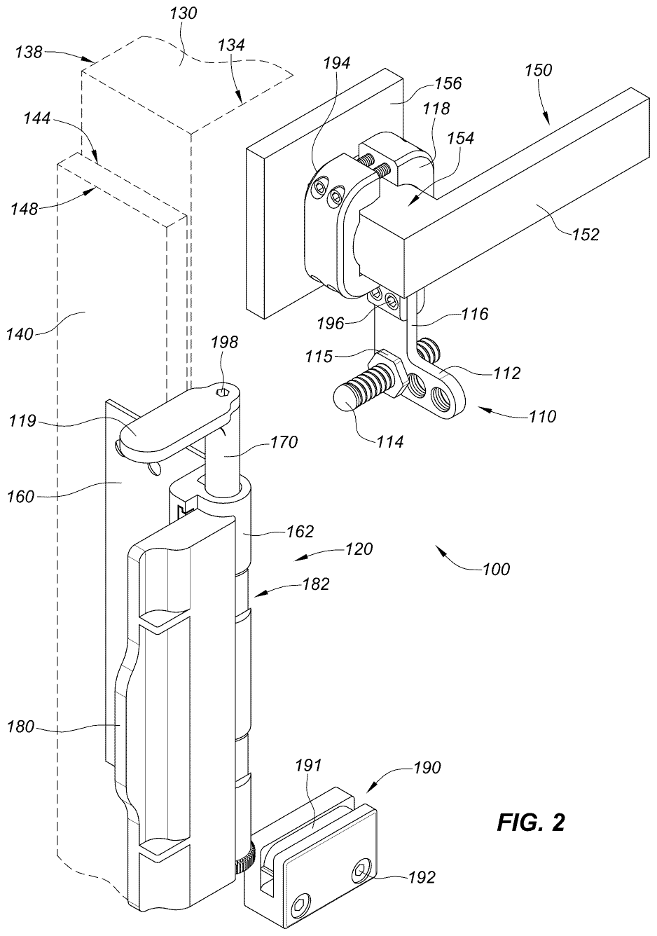

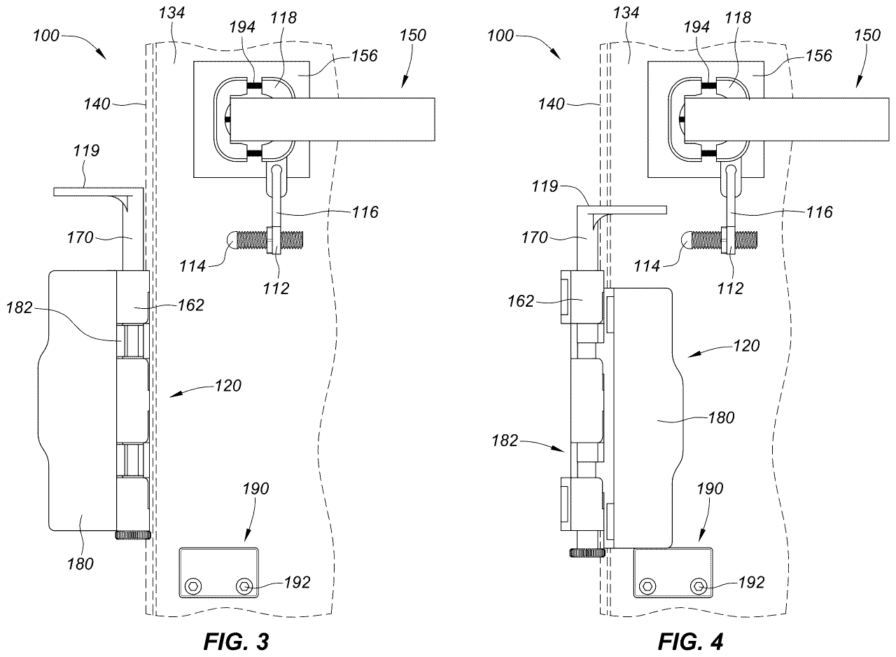

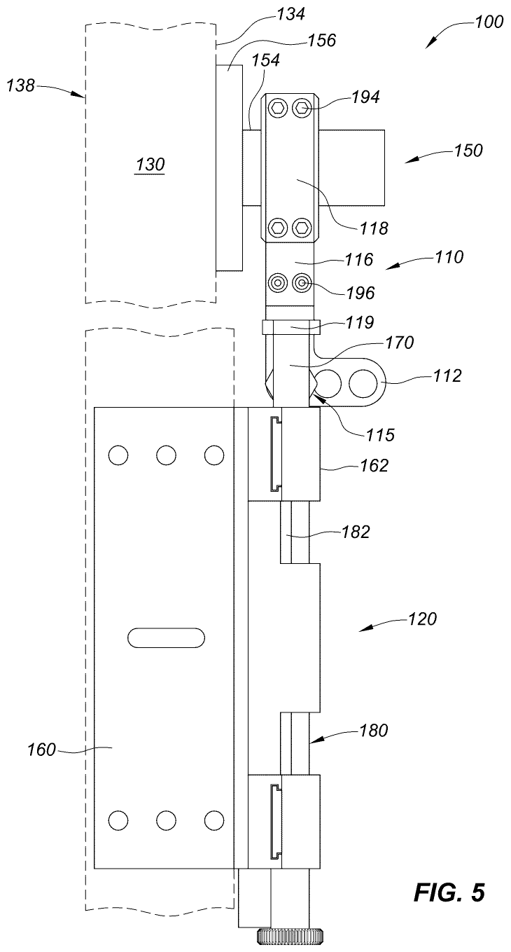

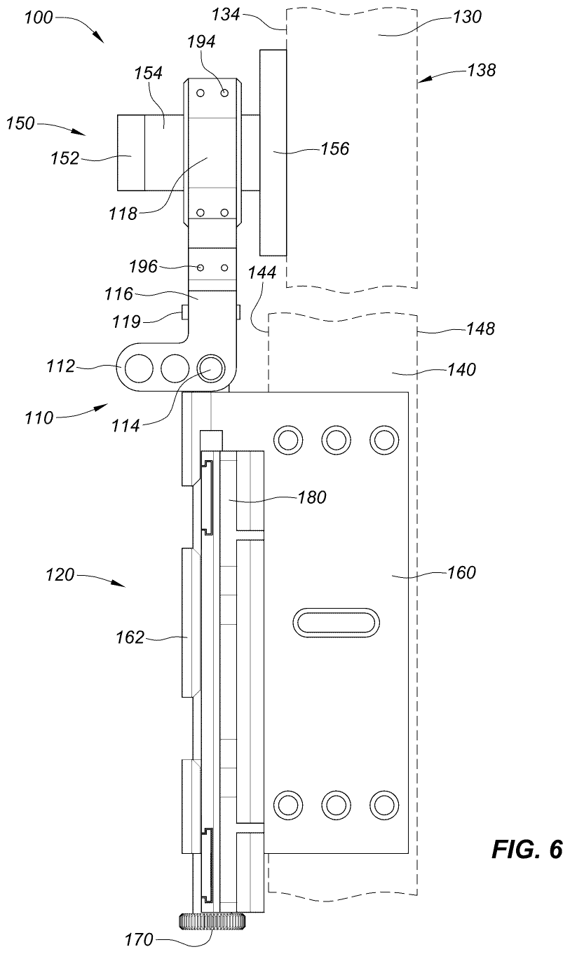

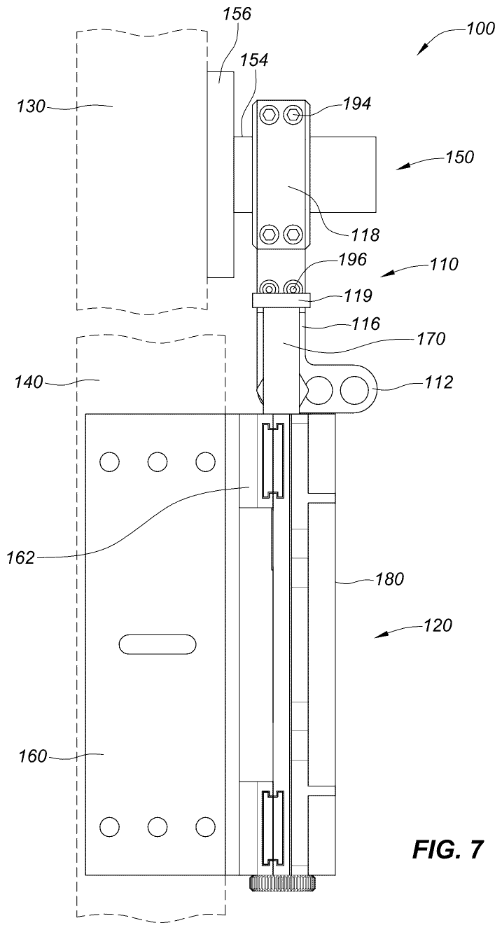

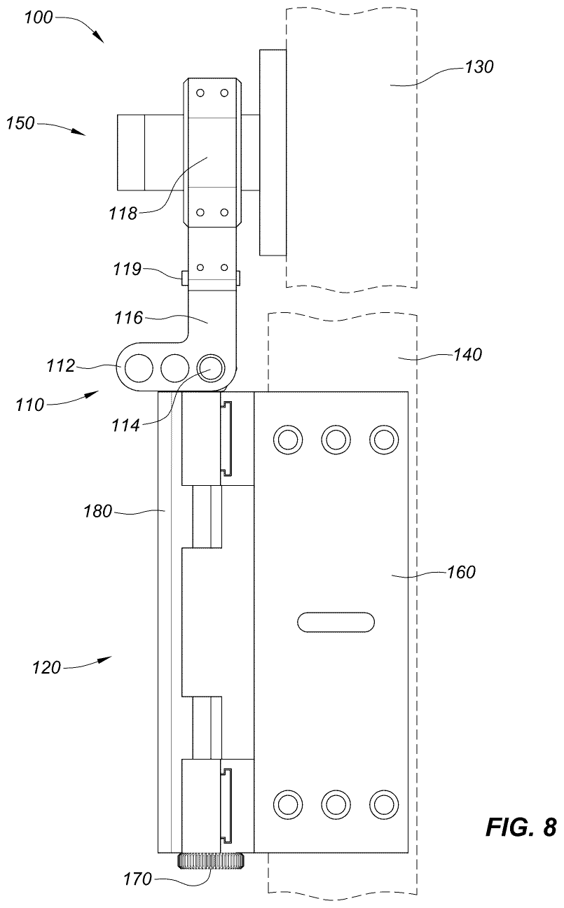

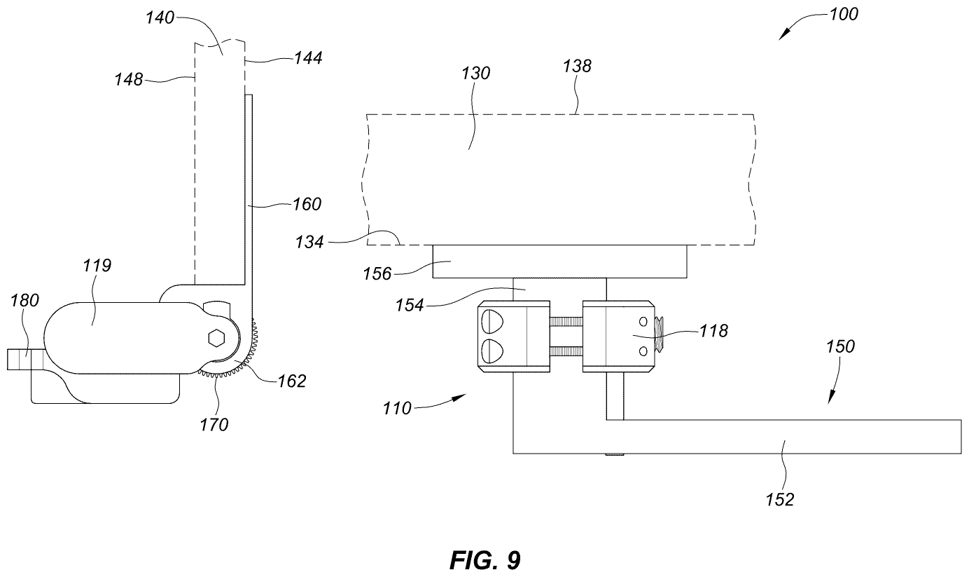

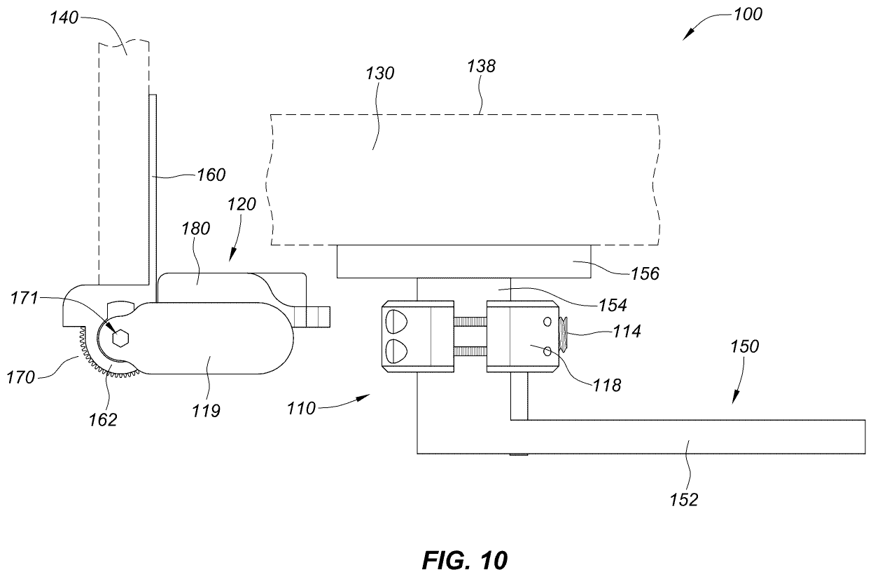

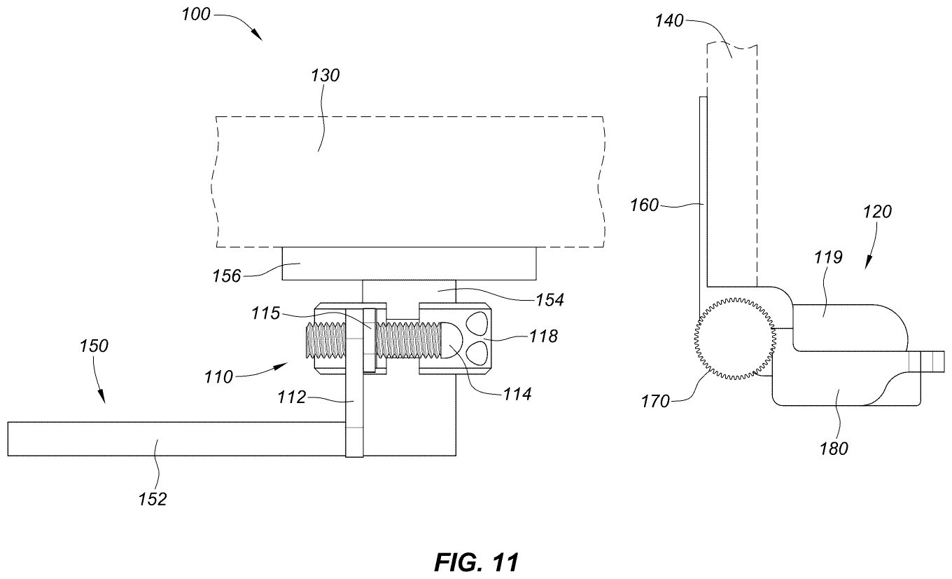

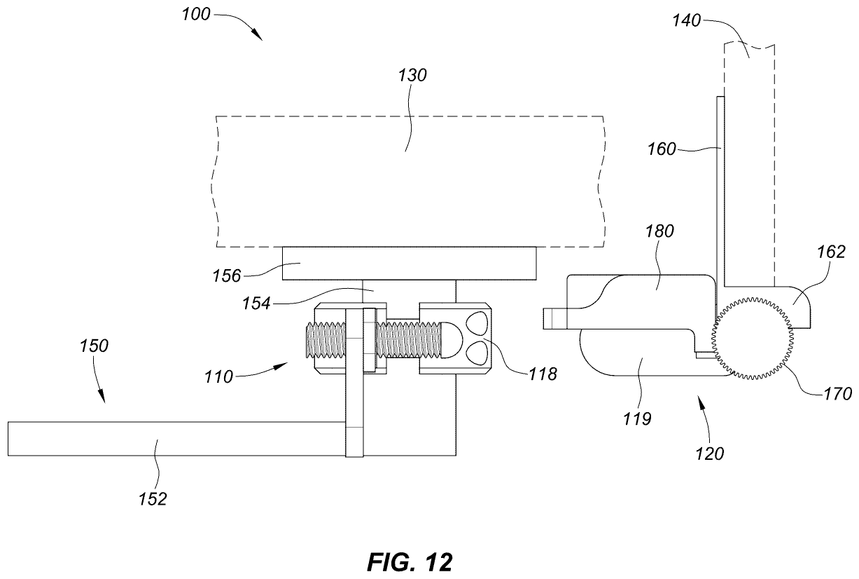

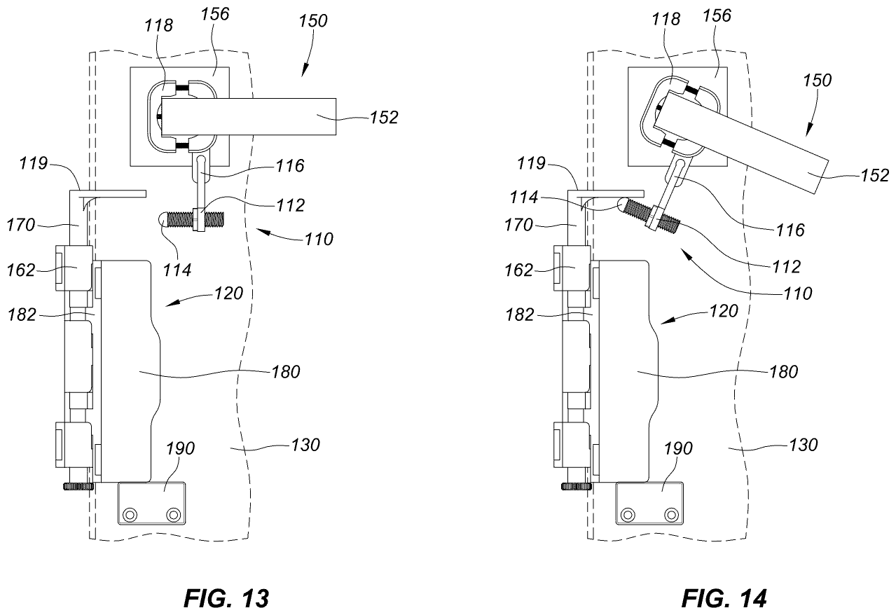

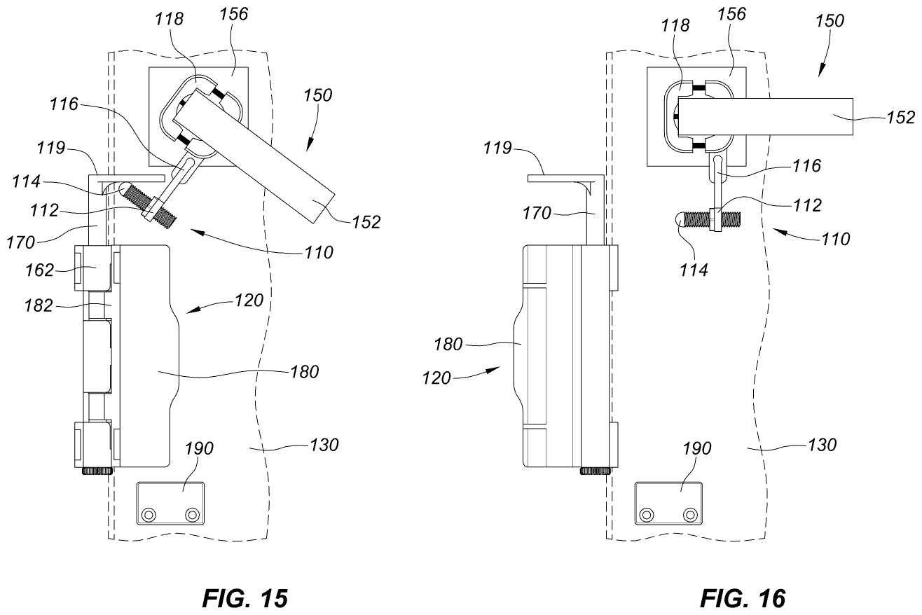

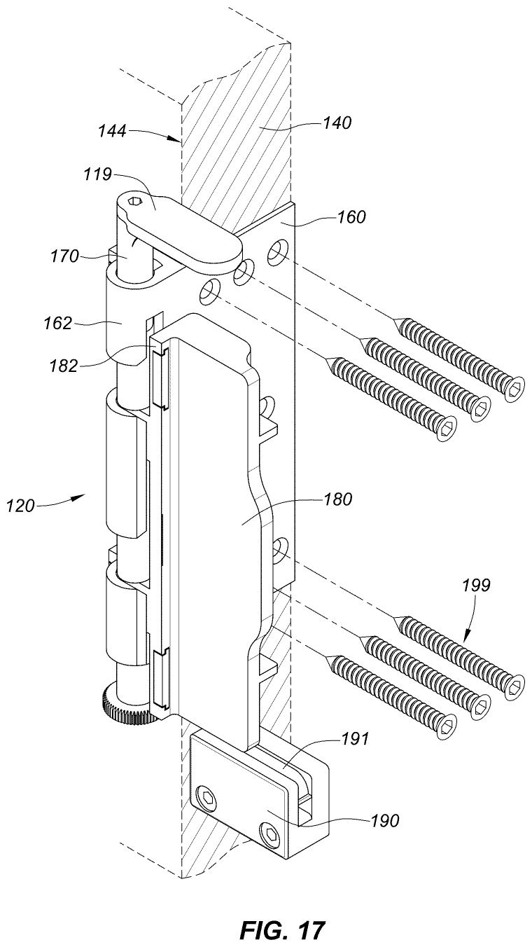

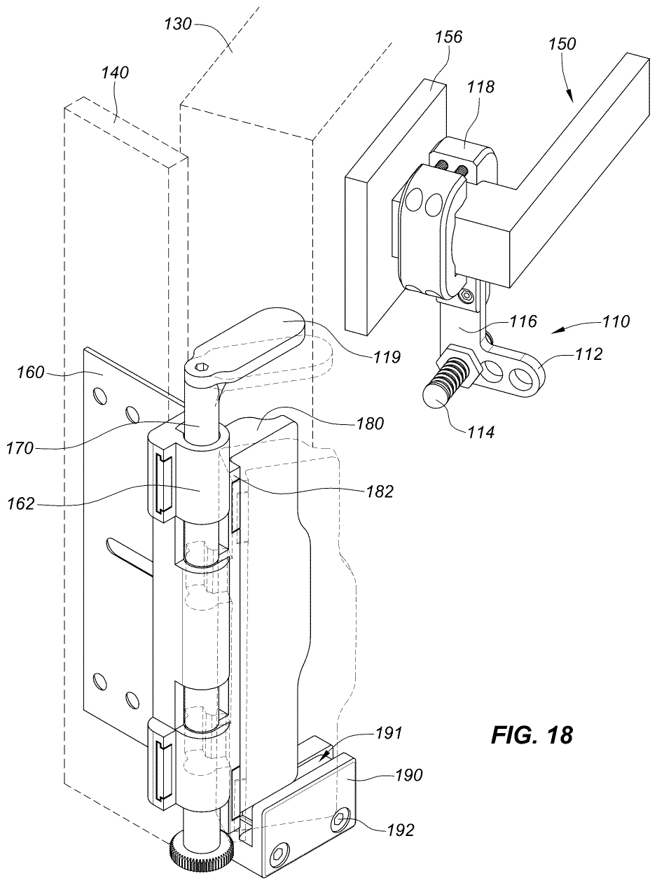

Referring to FIG. 1, a door mechanical security system 100 is adapted for installation and use on an in-swing door 130 and door frame 140 to prevent forced entry movement of the door 130 away from the door frame 140 in the closed position. Door 130 includes a door body supported on a set of door hinges (not show) opposite the door outer edge for in-swing movement about the door hinge axis between the door closed position shown in FIG. 1 and a range of open positions in relation to the door frame 140. An interior lever door handle assembly 150 is mounted on the door and extends through the door body between the oppositely disposed door major interior surface 134 and the door major exterior surface 138. The interior lever door handle assembly 150 includes a handle base 156 mounted to the door 130 and abutting the door major interior surface 134. The interior lever door handle assembly 150 includes a handle neck 154 supported on the handle base 156 for rotating movement through a limited range of travel. The interior lever door handle assembly 150 includes a handle lever 152 joined to the handle neck 154 for rotating movement in common with the handle neck 154 through a limited range of travel from a lever resting position wherein the handle lever 152 extends generally in the horizontal direction to a lever depressed position wherein the handle lever 152 extends generally about 45 degrees below the horizontal lever resting position. It will be understood that on the opposite, exterior side of the in-swing door 130 an exterior door handle (not shown) and handle locking mechanism (not shown) are accessible for opening the in-swing door, only when the handle locking mechanism (not shown) is accessed from the exterior with an exterior manual key, or an exterior keycode if an electronic lock system is installed, that configured to operate the handle locking mechanism (not shown) to access and open the interior lever door handle assembly 150 from the exterior. When the exterior manual key, or exterior keycode for an electronic lock system, is possessed by an authorized exterior human user, the authorized user can use the exterior manual key or exterior electronic keycode to operate the handle locking mechanism (not shown) from the exterior to access, turn, and open the interior lever door handle assembly 150 from the exterior. The door 130 can swing open from the closed position because the actuator assembly 110 is adapted to move with interior lever door handle assembly 150 to cause movement of the swing plate 180 upward from the locked lowermost position shown in FIG. 1 obstructing the door travel path, to the unlocked uppermost position shown in FIG. 2 clear of the door travel path. The door mechanical security system 100 thus is located on the interior side of the in-swing door 130 to prevent forced entry from the exterior and facilitate authorized entry from the exterior by an authorized human user in possession of the exterior manual key, or exterior keycode for an electronic exterior lock, necessary to actuate the interior lever door handle assembly 150 and actuator assembly 110 to lift and move the swing plate 180 from the locked lowermost position shown in FIG. 1 to the unlocked uppermost position shown in FIG. 2 to prevent the swing plate 180 from obstructing the door 130.

The door mechanical security system 100 includes a major locking hinge assembly 120 supported by the door frame 140 adjacent the outer edge of the door 130 on the interior side of the door 130 and door frame 140. The major locking hinge assembly 120 includes a fixed mounting plate 160 supported on the door frame 140 in fixed relationship to the door frame 140. The major locking hinge assembly 120 includes a plurality of threaded fasteners, such as screws, joining the fixed mounting plate 160 to the door frame 140 in fixed relationship thereto. The fixed mounting plate 160 includes a first set of hinge pin leaf receivers 162 spaced apart along a vertical hinge pin axis to capture and support an elongated hinge pin assembly 170 for pivoting movement about the vertical hinge pin axis.

The major locking hinge assembly 120 includes a travelling swing plate 180 supported by the hinge pin assembly 170 for pivoting movement about the vertical hinge pin axis in relation to the fixed mounting plate 160 and door major interior surface 134. The swing plate 180 is pivotably moveable between a first locked lowermost position shown in FIG. 1 and a second unlocked uppermost position shown in FIG. 2. The swing plate 180 includes a second set of hinge pin leaf receivers 182 spaced apart along the vertical hinge pin axis and intermediate the first set of hinge pin leaf receivers 162 of the fixed mounting plate 160 to capture the elongated hinge pin assembly 170. The swing plate 180 including the second set of hinge pin leaf receivers 162 thus is directly supported by the hinge pin assembly 170 and indirectly supported by the first set of hinge pin leaf receivers 162 of the fixed mounting plate 160. The swing plate 180 is gravity biased to remain in the locked lowermost position shown in FIG. 1 in relation to the fixed mounting plate 160 to prevent movement of the swing plate 180 out of a lowermost captured position in relation to a swing plate capture member 190 mounted on the door by threaded screw fasteners 192. The swing plate capture member 190 defines a swing plate capturing channel 191 configured to receive a captured portion of the swing plate 180, when the swing plate 180 is located in the locked lowermost position shown in FIG. 1. The captured portion of the swing plate 180 remains in the swing plate capturing channel 191 by effect of the gravity-biased configuration of the swing plate 180 in relation to the hinge pin assembly 170 and fixed mounting plate 160. The swing plate capture member 190 obstructs the captured portion of the swing plate 180 from being forced to swing out of the swing plate capturing channel 191 and away from the major interior surface 134 of the door 130. The swing plate capture member 190 defines the swing plate capturing channel 191 configured to receive a captured portion of the swing plate 180, when the swing plate 180 is located in the locked lowermost position shown in FIG. 1.

The swing plate 180 is supported for both pivoting movement and vertical translation movement between the first locked lowermost position adjacent the door major interior surface 134 and to obstruct the door from swinging inward along the door travel path as shown in FIG. 1 and the second unlocked uppermost position adjacent the door frame 140 and clear of the door travel path as shown in FIG. 2. The swing plate 180 is moveable in pivoting relationship relative to the fixed mounting plate 160 between the first locked lowermost position adjacent the door major interior surface 134 to obstruct the door from swinging inward along the travel path as shown in FIG. 1 and the second unlocked uppermost position adjacent the door frame and clear of the door swinging travel path as shown in FIG. 2 to allow in-swing movement of the door in relation to the door frame 140. The swing plate 180 is also supported for simultaneous vertical translation movement between the lowermost vertical position associated with the first locked lowermost position shown in FIG. 1 and the uppermost vertical position associated with the second unlocked uppermost position shown in FIG. 2. The swing plate 180 is gravity-biased to remain in the first locked lowermost position shown in FIG. 1 until lifted by positive external lifting force to the uppermost position shown in FIG. 2. The swing plate 180 is gravity-biased to return to the first locked lowermost position shown in FIG. 1 unless the swing plate 180 is also pivoted away from the locked lowermost position shown in FIG. 1 all the way through the swing plate pivoting range of motion to occupy the unlocked uppermost position shown in FIG. 2. that is located 180 degrees opposite from the locked lowermost position shown in FIG. 1.

Positive external lifting force and positive pivoting movement force may be provided by direct manual lifting of the swing plate 180 by a protected human user present on the interior side of the in-swing door 130 and door frame 140. In the alternative, positive external lifting force may be provided by indirect actuator lifting of the swing plate 180 by a protected human user present on the interior side of the in-swing door 130 and door frame 140 manually depressing the lever handle from the horizontal locked position shown in FIG. 1 to the fully depressed unlocked position shown in FIG. 2. In order to prevent entry by a potentially hostile unauthorized human user located outside the door, positive external lifting force cannot be provided by the potentially hostile unauthorized human user manually operating the exterior lever handle assembly (not shown) outside the door 130 and door frame 140 unless in possession of an exterior manual unlocking key or access code for an electronic keypad system adapted to unlock an exterior manual lock in a manner that also actuates the interior lever handle assembly 150 from outside the door. The unauthorized human user thus must gain possession of a manual access key for a manual exterior handle assembly lock, or an access code for an exterior keypad for an electronic exterior handle assembly locking mechanism, where operation of the lever handle assembly on the interior side of the door from the exterior side of the door is possible only by possession and use of the manual access key or access code. On the other hand, an authorized human user located outside the door, who needs to gain access to the interior side of the door 130 and door frame 140, may use the manual access key or access code in her/his possession to actuate and move the lever handle assembly from the horizontal locked position to the fully depressed unlocked position. In the alternative, an authorized human user located outside the door, who needs to gain access to the interior side of the door 130 and door frame 140, may speak through the closed door and persuade the authorized protected human user located inside the door and door frame to unlock the major locking hinge assembly 120 by manually moving the swing plate 180 from the locked lowermost position shown in FIG. 1 to the unlocked uppermost position shown in FIG. 2 to clear the door swing travel path and also manually depress the lever handle assembly 150 to permit the in-swing door to swing open.

The door mechanical security system 100 includes an actuator assembly 110 adapted to provide indirect lifting force and pivoting force sufficient to unlock the major locking hinge assembly 120 by operation of the interior lever handle assembly 150. The actuator assembly 110 includes a two-part collar sub-assembly 118 joined by a set of threaded fasteners 194, which may be bolt and nut combinations. The collar sub-assembly 118 is adapted to be mounted to the neck 154 to rotate in common with the neck 154 when the door lever handle is moved. The actuator assembly 110 includes an actuator arm 116 affixed to the collar sub-assembly 118 by a set of threaded fasteners 196 to carry an actuator pin 114. The actuator pin 114 is adapted to move through an arc in relation to a lifting cap 119 to lift the lifting cap 119 in relation to movement of the interior lever door handle assembly 150. The actuator assembly 110 includes the lifting cap 119 affixed to the elongated hinge pin assembly 170 for lifting the hinge pin assembly 170 and swing plate 180 when the interior door lever handle assembly 150 is operated. The actuator assembly 110 thus lifts the hinge pin assembly 170 to move the swing plate 180 from the locked lowermost position shown in FIG. 1 to the unlocked uppermost position shown in FIG. 2. The swing plate rotates outward 180 degrees from adjacent the major interior surface 134 of the door 130 to obstruct the door from swinging open in the locked lowermost position shown in FIG. 1, to adjacent the door frame 140 and clear of the door travel path to allow the door to swing open in the unlocked uppermost position shown in FIG. 2.

Apparatus, methods and systems according to embodiments of the disclosure are described. Although specific embodiments are illustrated and described herein, it will be appreciated by those of ordinary skill in the art that any arrangement which is calculated to achieve the same purposes can be substituted for the specific embodiments shown. This application is intended to cover any adaptations or variations of the embodiments and disclosure. For example, although described in terminology and terms common to the field of art, exemplary embodiments, systems, methods and apparatus described herein, one of ordinary skill in the art will appreciate that implementations can be made for other fields of art, systems, apparatus or methods that provide the required functions. The invention should therefore not be limited by the above-described embodiments, methods, and examples, but by all embodiments and methods within the scope and spirit of the invention.

In particular, one of ordinary skill in the art will readily appreciate that the names of the methods and apparatus are not intended to limit embodiments or the disclosure. Furthermore, additional methods, steps, and apparatus can be added to the components, functions can be rearranged among the components, and new components to correspond to future enhancements and physical devices used in embodiments can be introduced without departing from the scope of embodiments and the disclosure. One of skill in the art will readily recognize that embodiments are applicable to future systems, future apparatus, future methods, and different materials.

All methods described herein can be performed in a suitable order unless otherwise indicated herein or otherwise clearly contradicted by context. The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein. Terminology used in the present disclosure is intended to include all environments and alternate technologies that provide the same functionality described herein.

What is claimed is:

1. A door mechanical security system for installation on an in-swing door having an interior lever handle assembly, the interior lever handle assembly isolated from actuation from the door exterior unless actuated by an exterior key, said system comprising:
a stationary mounting plate to be installed on the door frame in fixed relationship thereto;
an elongated hinge pin assembly supported on the mounting plate for rotating movement relative thereto;
a traveling swing plate mounted on the hinge pin assembly for pivoting movement in relation to the mounting plate, the swing plate adapted for vertical translation movement in relation to the mounting plate between a locked lowermost position and an unlocked uppermost position, the swing plate obstructing the door travel path in the locked lowermost position, the swing plate clear of the door travel path in the unlocked uppermost position;
an actuator assembly mounted to the neck of the interior lever handle assembly for movement in common with the neck of the interior lever handle assembly when the interior lever handle assembly is actuated by the exterior key, the actuator assembly including an actuator pin supported for movement to lift a lifting cap affixed to the hinge pin assembly to cause movement of the swing plate from the locked lowermost position to the unlocked uppermost position.

2. The door mechanical security system of claim 1 and further comprising:
the swing plate, mounting plate and hinge pin assembly adapted for both pivoting movement and translation movement between the locked lowermost position to the unlocked uppermost position, the swing plate in the locked lowermost position being adjacent a major interior surface of the door to obstruct opening movement of the door from closed position, the swing plate in the unlocked uppermost position being adjacent the door frame and clear of the door travel path.

3. The door mechanical security system of claim 1 and further comprising:
the actuator assembly including a mounting collar mounted to the handle neck for rotation movement with the handle neck;
the actuator assembly including a lifting arm affixed to the mounting collar for common movement with the mounting collar;
the actuator assembly including a lifting pin affixed to the lifting arm in spaced relation to the handle neck for lifting movement relative to a lifting cap mounted on the hinge pin assembly for lifting the hinge pin assembly and swing plate in relation to the fixed mounting plate.
